(19) United States
(12) Patent Application Publication
(10) Pub. No.: US 2026/0117079 A1
(43) Pub. Date: Apr. 30, 2026

(54) PFA-FREE IMAGE RECEIVER MEDIA FORMULATIONS

(71) Applicant: Kodak Alaris LLC, Rochester, NY (US)

(72) Inventors: Teh-Ming Kung, Rochester, NY (US); Brenden Otero, Rochester, NY (US); Taylor Chudyk, Rochester, NY (US); Matthew Croteau, Rochester, NY (US); Walt E. Scott, Rochester, NY (US)

(73) Assignee: Kodak Alaris LLC, Rochester, NY (US)

(21) Appl. No.: 19/368,167

(22) Filed: Oct. 24, 2025

Related U.S. Application Data
(60) Provisional application No. 63/711,509, filed on Oct. 24, 2024.

(51) Int. Cl. C09D 5/26; B41M 5/44; B41M 5/52; C09D 5/02; C09D 7/45; C09D 7/63; C09D 167/00

(52) U.S. Cl. CPC C09D 5/26; B41M 5/44; B41M 5/5227; C09D 5/022; C09D 5/027; C09D 7/45; C09D 7/63; C09D 167/00; B41M 2205/34; B41M 2205/40; B41M 2205/42

(57) ABSTRACT

A thermal receiver for image production. The thermal receiver maintains advantageous properties such as surface tension while being made with chemicals with fewer health, safety, and environmental concerns than previous thermal receivers. This includes the elimination of hazardous catalysts and PFAS/fluorinated surfactants from the composition through the use of silicone compatibilizers and trisiloxane surfactants. The composition has low surface tension within a short time frame after being applied to a surface.

### CROSS-REFERENCE TO RELATED APPLICATION(S)

This application is related to and claims the benefit of priority from U.S. Provisional Application No. 63/711,509, titled “PFA-FREE IMAGE RECEIVER MEDIA FORMULATIONS,” filed on Oct. 24, 2024, and the full disclosure of which is incorporated by reference herein in its entirety for all intents and purposes.

### FIELD OF DISCLOSURE

Embodiments of the present disclosure pertain to compositions for thermal receiver elements used in thermal printing processes. More specifically, the embodiments of thermal receiver elements are free of per- and polyfluoroalkyl substances (“PFAS”).

### BACKGROUND

Thermal transfer systems have been developed to obtain prints from pictures that have been generated from a camera or scanning device. According to one way of obtaining such prints, an electronic picture is first subjected to color separation by color filters. The respective color-separated images are then converted into electrical signals. These signals are then transmitted to a thermal printer. In thermal printing, dye transfers from a donor element to a thermal image receiver, where it is absorbed into a dye-receiving layer. The donor element is a separate sheet or ribbon that contains dye, typically in solid form, and the donor element is typically a cyan, magenta, or yellow dye donor element. The donor element is placed in contact with the receiver during imaging, and release agents in the receiver help prevent sticking between the two layers during this process. The donor element and the thermal image receiver element are then inserted between a thermal printing head and a platen roller. A line-type thermal printing head is used to apply heat from the back of the dye-donor element. The thermal printing head has many heating elements and is heated sequentially in response to one of the cyan, magenta, or yellow signals. The process is then repeated for the other colors. A color hard copy is thus obtained which corresponds to the digitally captured original picture viewed on a screen.

The formulation of the receiver element is important for image quality. Poor thermal receivers may produce printing defects such as white spots. However, current thermal receiver formulations often use chemicals with significant safety, health, and environmental concerns.

Some thermal receivers in the industry may use highly reactive and hazardous catalysts. For example, one chemical used in these thermal receivers has been dibutyltin dilaurate. Dibutyltin dilaurate is a neurotoxin that may cause injuries to the liver, kidneys, and gastrointestinal tract, and may be absorbed through the skin. It is flammable and may further release toxic fumes and smoke when on fire. Dibutyltin dilaurate is also reactive with acids and oxidizers, creating additional hazard concerns. Due to the environmental, health, and safety concerns with these catalysts, it may be advantageous to phase these catalysts out.

Additionally, some thermal receivers have used per- and polyfluoroalkyl substances (“PFAS”) such as fluorinated surfactants. The United States Food and Drug Administration (“FDA”) and the United States Environmental Protection Agency (“EPA”) have identified PFAS as long-lasting chemicals of concern. They have had widespread use resulting in PFAS being found in water, air, fish, marine life, and soil around the globe. Additionally, studies have shown that the use of PFAS may be linked to harmful effects in humans and animals.

### SUMMARY

Applicant recognized the problems noted above herein and conceived and developed embodiments of compositions of thermal receiver elements, according to the present disclosure, that solely include PFA-free substances.

In an embodiment of the present disclosure, a composition for a thermal receiver element includes a trisiloxane surfactant and a silicone compatibilizer. The trisiloxane surfactant includes at least one of an ethoxylated polydimethylsiloxane, a distillate from a mono-functional trisiloxane intermediate, or a polyether-modified siloxane. The silicone compatibilizer includes at least one of a silicone polyether, a silicone glycol copolymer, an organo-modified silicone that is dispersible in water, a siloxane-based Gemini surfactant, a polyether siloxane copolymer, or a polyether-modified polydimethylsiloxane.

In another embodiment of the present disclosure, a thermal imaging receiver system includes a substrate, an image-receiving layer disposed on the substrate, the image-receiving layer including a dye-receiving layer (DRL) configured to receive thermally transferred dye from a donor element during thermal imaging and a receiver overcoat (ROC) layer disposed over the DRL. The DRL includes a silicone compatibilizer and a trisiloxane surfactant. The ROC layer includes a polymer binder matrix, the polymer binder matrix including at least one of a water-dispersible acrylic polymer, a water-dispersible polyester, or a water-dispersible conductive polymeric material.

### BRIEF DESCRIPTION OF THE DRAWINGS

The present technology will be better understood upon reading the following detailed description of non-limiting embodiments and examining the accompanying drawings, which are summarized as follows:

FIG. 1 depicts a graph of dynamic surface tension over time with respect to various trisiloxane surfactants (C #2-C #7) and the fluorinated PFAS surfactants (BM #1 and BM #2);

FIG. 2 depicts a graph of dynamic surface tension over time at different concentrations of a trisiloxane surfactant in deionized water;

FIG. 3 depicts a graph of dynamic surface tension over time comparing a trisiloxane surfactant (C #2) and a silicone compatibilizer (C #12) alone, and in combination (IE #1);

FIG. 4A depicts a graph of dynamic surface tension over time comparing various trisiloxane surfactants (C #2-C #7) and a silicone compatibilizer (C #12) alone, and in combinations

(IE #1-IE #6);

FIG. 4B depicts a graph of dynamic surface tension over time comparing a trisiloxane surfactant (C #3) and a silicone compatibilizer (C #12) alone, and in combination (IE #2);

FIG. 5 depicts a graph of dynamic surface tension over time with respect to various silicone compatibilizers;

FIG. 6 depicts a graph of dynamic surface tension over time comparing a trisiloxane surfactant (C #2) and various silicone compatibilizer (C #12-C #18) alone, and in combination (IE #1, IE #7-IE #12);

FIG. 7 depicts a graph of dynamic surface tension over time with respect to a trisiloxane surfactant and a silicone compatibilizer at various blend ratio of a silicone compatibilizer to a trisiloxane surfactant;

FIG. 8 depicts a graph of dynamic surface tension over time with respect to a trisiloxane surfactant and various silicone compatibilizers at various blend ratios of silicone compatibilizer to trisiloxane surfactant (IE #24-IE #31); and

FIG. 9 depicts a graph of dynamic surface tension over time comparing an aqueous dispersion of thermal dye-receiving layer comprising a blend of a trisiloxane and various silicone compatibilizers in combination (IE #32-IE #35) and an aqueous dispersion of thermal dye-receiving layer comprising a PFAS fluorinated surfactant (BM #3).

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/−10 percent.

The technology of the present disclosure provides for compositions of thermal receiver elements. The composition may maintain high image quality when used while avoiding hazardous chemicals used in prior art compositions, including, but not limited to, PFAS.

Embodiments of the present disclosure provide for a thermal receiver for producing printing images. The dye-receiving layer of the thermal receiver may comprise one or more of: a static control agent, a first and second dispersant, a crosslinker, a film former, a release agent, a silicone compatibilizer, a dye-receiving layer (DRL) latex binder, a trisiloxane surfactant, or a defoamer. A silicone compatibilizer and a trisiloxane surfactant may be included to replace chemicals with safety, health, and environmental issues within the dye-receiving layer of the thermal receiver. Accordingly, PFAS based surfactants may be eliminated from the dye-receiving layer and, instead, a silicone release agent may be employed, the silicone release agent having much reduced tin catalyst from the dye-receiving layer of the thermal receiver. For example, the amount of tin catalyst in the silicone release agent may be reduced by approximately 80% from approximately 5000 parts per million (ppm) to approximately 1000 ppm. The thermal receiver may maintain image quality despite the different formulation.

A key metric for these thermal receivers is the change in dynamic surface tension over a period of time after the thermal receiver is applied to a substrate. For industrial production applications, a reduced surface tension within the first 100 milliseconds (or, if possible, within the first 50 milliseconds or even 10 milliseconds) may be critical for high-speed coating and spraying applications. The combination of trisiloxane surfactant and silicone compatibilizer may be advantageous in reaching these surface tension requirements. This may result in similar or better properties to previously used fluorinated surfactants, while being without the hazardous materials used in these receivers.

Table 1 below provides an embodiment of the composition of the current technology. In embodiments, the thermal receiver element may include a static control agent, a first dispersant, a second dispersant, a crosslinker, a film former, a release agent, a silicone compatibilizer, a DRL matrix binder, a trisiloxane surfactant, and a defoamer. However, it should be appreciated that the thermal receiver element may be functional without one or more of these components. Ranges of weight percentage (wt %) of components of viable compositions of the thermal receiver element are given in different columns of Table 1.

TABLE 1

| | Composition | Composition | Composition |
|---|---|---|---|
| | Range 1 | Range 2 | Range 3 |
| Component | (wt %) | (wt %) | (wt %) |
| Static Control Agent | 0.48-1.2 | 0.48-1.0 | 0.6-0.8 |
| First Dispersant | 0-4 | 1.5-3.5 | 1-3 |
| Second Dispersant | 0-4 | 1.5-3.5 | 1-3 |
| Crosslinker | 5-10 | 6-9 | 6.5-8.5 |
| Film Former | 6-10 | 6-9 | 6.5-8.5 |
| Release Agent | 1-4 | 2-3.5 | 2.5-3.5 |
| Silicone Compatibilizer | 0.01-3.0 | 0.06-1.6 | 0.08-1.4 |
| DRL Latex Binder | 60-89 | 67-83 | 71-82 |
| Trisiloxane surfactant | 0.1-3.0 | 0.6-1.6 | 0.8-1.4 |
| Defoamer | 0.5-1.5 | 0.6-1.5 | 0.8-1.2 |

The static control agent may be a highly conductive thermoelectric material to distribute any static buildup in the composition. In this context, a highly conductive thermoelectric material may be defined as having a sheet resistance in the range of approximately 2-4 log (ohm/square) (i.e., approximately 100 to 10,000 ohms per square). The static control agent may include poly (3,4-ethylenedioxythiophene) polystyrene sulfonate (“PEDOT:PSS”). In some embodiments, the static control agent may be Heraeus Clevios P10 or PH1000 etc.

Dispersing agents, also known as dispersants, are typically materials that strongly adsorb on to dispersed particles and/or particulates. To provide optimal performance, dispersed particles and/or particulates must act independently of each other and thus must remain well dispersed throughout manufacture, storage, application, and film formation. To achieve these advantageous properties, certain embodiments of the present technology have a dye-receiving layer that comprises one or more surfactants in combination with one or more dispersants. In the embodiment displayed in Table 1, the first dispersant may be Kodak BmEK-77.

The second dispersant may be an acrylate block copolymer. The dispersant may have a defined polymer architecture and a low poly-dispersity index. In some embodiments, the second dispersant may be BASF Dispex Ultra PX 4585.

Crosslinking agents that may be included in the aqueous image receiving layer formulation and/or the aqueous coatable receiver overcoat layer are chosen to be reactive with the particular reactive groups on the water-dispersible acrylic polymers incorporated into the polymer binder matrix. For example, for the reactive carboxyl and carboxylate groups, the useful crosslinking agents may be carbodiimides and aziridines.

One or more crosslinking agents may be present in either or both of the aqueous image receiving layer formulation or aqueous receiver overcoat layer formulation, in an amount that may be essentially a 1:1 molar ratio, or less, with the reactive groups in the water-dispersible acrylic polymer in the formulation. In general, useful crosslinking agents include but are not limited to, organic compounds such as melamine formaldehyde resins, glycoluril formaldehyde resins, polycarboxylic acids and anhydrides, polyamines, epihalohydrins, diepoxides, dialdehydes, diols, carboxylic acid halides, ketenes, aziridines, carbodiimides, isocyanates, and/or mixtures thereof.

The cross-linker may be a polycarbodiimide based crosslinking agent with a hydrophilic segment. The cross-linker may be Carbodilite V-02-L2 (Nisshinbo Chemical Inc., Japan) in some embodiments.

The film former may be a water-dispersible polyester binder. The film former may be Tuftone KEM-09 (Kao Corporation, Japan).

In some embodiments, the aqueous coatable dye-receiving layer and/or the receiver overcoat layer comprises one or more water-dispersible release agents that may reduce sticking that occurs between a thermal donor element and the thermal image receiver element during thermal imaging. These compounds are generally not water-soluble, but are water dispersible, so that they are dispersed uniformly within the aqueous image receiving layer formulation (described herein). Release agents may also help provide a uniform film in the dye image receiving layer during formulation and drying. These compounds may be polymeric or non-polymeric, but are typically polymeric. Such compounds are not generally re-dispersible once they are coated and dried in the aqueous coatable dye-receiving layer.

Useful water-dispersible release agents may include but are not limited to, water-dispersible fluorine-based surfactants, silicone-based surfactants, modified silicone oil (such as epoxy-modified, carboxy-modified, amino-modified, alcohol-modified, fluorine-modified, alkylarylalkyl-modified, and others known in the art), and polysiloxanes. For context, during a thermal printing process, an “useful” release agent in a DRL will help a smooth separation of the spent donor and the imaged receiver sheet without causing donor-receiver sticking and the consequential image defects, such as, chatters (e.g., stick-slip line patterns perpendicular to the printing direction), unwanted transfer of the dye layer to the DRL surface of the receiver sheet, unwanted transfer of the DRL to the surface of dye layer of the donor ribbon, or a ripped donor ribbon in a severe donor-receiver sticking situation. Useful modified polysiloxanes include but are not limited to, water-dispersible polyoxyalkylene-modified dimethylsiloxane graft copolymers having at least one alkylene oxide pendant chain having more than 45 alkoxide units, as described in U.S. Pat. No. 5,356,859 (Lum et al.), which is incorporated herein by reference. Other useful release agents include crosslinked amino modified polydimethylsiloxanes that may be supplied as emulsions under the trade name SILTECH from Siltech Corporation.

The release agent may be a crosslinked amino modified silicone fluid. The release agent may have approximately 30% active emulsion of a highly cross-linked amino siloxane. The release agent may have a reduced catalyst concentration over previous release agents used in thermal receiver formation. In the reduced catalyst release agent, the amount of catalyst in the release agent may be less than 1000 ppm or 0.1% weight. The catalyst concentration may be in the range of 0.05-0.09% or 500-900 ppm. In some embodiments, the release agent may be Siltech E-2150 LT (Siltech Corp.).

In some embodiments, the silicone compatibilizer may be a modified silicone fluid which is water soluble or miscible. Depending on the modified molecular structure and the molecular weight of the silicone compatibilizer, the silicone compatibilizer has a varied degree of solubility, miscibility, or dispersibility with other hydrophobic or hydrophilic silicone fluids, including trisiloxanes and trisiloxane derivatives which may have a varied degree of water miscibility and solubility. The silicone compatibilizer may help trisiloxane and trisiloxane derivatives, which are water immiscible, have limited water dispersibility or have a varied degree of water miscibility and solubility. The silicone compatibilizer may help form a finer and better dispersed phase or a homogeneous phase in water to prevent coalescence, agglomeration, creaming, sedimentation, and/or separation to enable and enhance the use of the given amount of trisiloxane(s) in any intended aqueous applications. In other words, for trisiloxane and trisiloxane derivatives, particularly for those which are water-immiscible, have limited water dispersibility, or have a varied degree of water miscibility and solubility, the incorporation of the silicone compatibilizers possessing amphoteric nature (i.e., both hydrophilic and siliconephilic) can assist or facilitate the formation of a stable dispersion comprising fine nano-micron sized liquid droplets or soft particulates evenly distributed as a dispersed phase in water via mechanical or physical means. The silicone compatibilizer may also solubilize the trisiloxane and trisiloxane derivatives to form a stable uniform single phase with water. On the contrary, in the absence of a silicone compatibilizer, the mix of the trisiloxane and its derivatives usually may form an unstable dispersion comprising coarse liquid droplets unevenly distributed as a dispersed phase in water. As time elapses, the unstable and unevenly dispersed liquid droplets of trisiloxane and trisiloxane derivatives may coalesce into larger droplets or particulates and likely may settle as a separate layer or a visually distinct non-uniform phase dispersed in a continuous phase of water. As a consequence, objectionable coating defects, such as, voids, streaks, line defects, and mottles, may be observed in the resultant coatings.

The silicone compatibilizer may also lower the dynamic surface tension of the silicone fluids in an aqueous formulation, such as trisiloxanes, to meet and enhance high-speed wetting and spreading applications. “High-speed” wetting and spreading applications may be defined as greater than approximately 100 meters per minutes (mpm).

In some embodiments, the silicone compatibilizer may be a highly branched silicone polyester. The silicone compatibilizer may have certain methyl groups replaced with polyalkyleneoxide chains to increase solubility and reduce surface tension. In some embodiments, the silicone compatibilizer may be an ultra-highly branched silicone polyether, such as, Silsurf Q25315-O or Silsurf Q20308. The silicone compatibilizer may have a structure as shown below wherein R represents polyether chains.

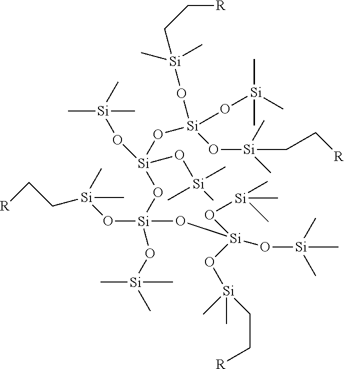

In other embodiments, the silicone compatibilizer may be an MQ silicone polyether resin, a silicone glycol copolymer, an organo-modified silicone that may be dispersible in water, a siloxane-based Gemini surfactant, a polyether siloxane copolymer, or a polyether-modified polydimethylsiloxane. In terms of branched silicone compatibilizers, “branched” may be defined as a few side chains (e.g., low-density polyethylene or LDPE), “highly branched” may be defined as hyperbranched polyesters, and “ultra-highly branched” may be defined as dendritic or dense 3-D networks, for example, MQ silicone polyether resins, with M units as monofunctional siloxane units (e.g., R₃SiO_{1/2}), which are typically terminal groups, Q units as tetrafunctional siloxane units (SiO_{4/2}), and R units as a hydrophilic polyether modification introduced into the silicone backbone). The silicone compatibilizer may be a PEG-8 dimethicone. The silicone compatibilizer may alternatively be a Siltech Silsurf A208, a Siltech C-570, an Evonik TEGO Twin 4100, an Evonik TEGO Glide 496, a BYK 3455, among others.

The DRL latex binder may be BYK-LP X 23899 Latex.

The receiver overcoat (ROC) layer comprises a polymer binder matrix that may include: (1) a water-dispersible acrylic polymer; (2) a water-dispersible polyester; and (3) a water-dispersible conductive polymeric material. In another embodiment of the ROC layer, the ROC layer comprises a polymer binder matrix that may include just (1) a water-dispersible acrylic polymer; and (2) a water-dispersible polyester. The ROC layer may further comprise one or more release agents, one or more crosslinking agents, one or more antifoamers, and one or more surfactants or emulsifiers. In some embodiments, an amount of surfactant may be added to the aqueous ROC dispersion. Namely, surfactant may be added to the ROC dispersion after the acrylic polymer is already formed, which is in addition to the amount of surfactant that is used as an emulsifier in the manufacture or suspension of the acrylic polymer. Hence, such added surfactant may sometimes be referred to herein as “additional surfactant.” One skilled in the art would appreciate the fact that a surfactant/emulsifier may be used to manufacture acrylic polymers with water dispersible properties.

In certain other embodiments, instead of adding “additional surfactant” after manufacturing the water-dispersible acrylic polymer, “excess surfactant” may be added at the time that the acrylic polymer is made. This excess surfactant is an extra amount of surfactant in excess of what is required to actually make the acrylic polymer and is added at the time that the acrylic polymer is actually made. Generally, surfactant in the amount of 1% may be provided for the manufacture of acrylic polymers. Thus, “excess surfactant” may be defined as the amount of surfactant used to make the acrylic polymers that is in excess of 1%.

The trisiloxane surfactant generally has challenges reducing the dynamic surface tension to an acceptable level in high-speed aqueous coating applications. This may be because of the limited water solubility and/or dispersibility of the surfactant. However, the addition of the silicone compatibilizer may drastically improve the dynamic surface tension of the technology. This may result in a sufficiently low dynamic surface tension without excessive surfactant usages of the trisiloxane. Excessive trisiloxane may result in undesirable coating defects and unwanted surface properties in the coating, particularly without the presence of a silicone compatibilizer. As a result, the incorporation of the silicone compatibilizer into the formulation allows for the use of the trisiloxane surfactant which meets environmental, safety, and health requirements that cannot be met by the prior art surfactant.

Additionally, the combination of the trisiloxane surfactant and silicone compatibilizer may result in better dynamic surface tensions than what has been achieved with fluorinated surfactants. The dynamic surface tension of the trisiloxane surfactant and silicone compatibilizer in combination may also be better than what would be achieved by each component individually. This may result in a superior print quality standard when in use.

The trisiloxane surfactant may be a very low molecular weight ethoxylated polydimethylsiloxane. The molecular weight (MW) range for polyether-modified trisiloxane surfactants usually ranges from approximately 400 to approximately 1500 g/mol. Therefore, in this context, a MW in the range of approximately 400 to approximately 800 g/mol would be considered “very low” MW, and a MW in the range of approximately 800 to approximately 1000 g/mol would be considered “low” MW. The trisiloxane surfactant may be distilled from a mono-functional trisiloxane intermediate. The trisiloxane surfactant may be a polyether-modified siloxane. In some embodiments the trisiloxane surfactant may be Silsurf A004-UP, Silsurf A008-UP, CoatOsil 77, CoatOsil 7608, BREAK-THRU S240, Nufarm EXPAND, BYK 3450, or BYK 3451. The trisiloxane surfactant may be used to replace prior art fluorinated surfactants. The trisiloxane surfactant may have a structure as shown below:

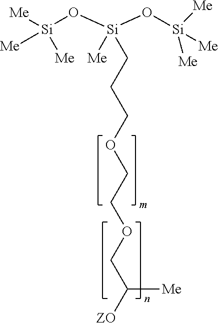

The defoamer may be a polyether siloxane copolymer emulsion. In some embodiments, the defoamer may be Evonik Foamex 825.

A critical factor in the formulation of the thermal receiver may be the dynamic surface tension of the formulation. Due to the high production speeds of the thermal receiver, a low dynamic surface tension may be required to ensure even distribution of the composition during production. Surface tension may often be measured in relation to surface age based on when the composition is initially distributed onto a substrate.

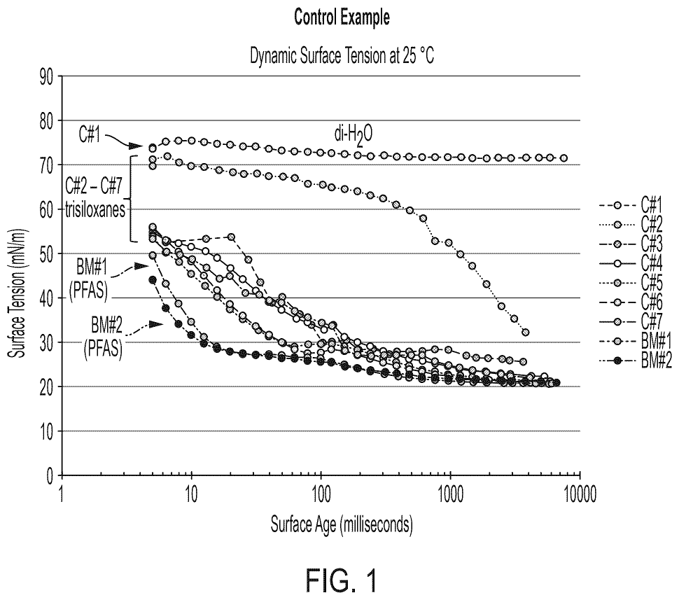

FIG. 1 illustrates a diagram of dynamic surface tension at 25 degrees Celsius with respect to surface age. Surface tensions are provided in millinewtons per meter (mN/m) and surface age is measured on a logarithmic scale in milliseconds (ms). At the top of the figure, deionized water (di-H₂O), labeled as C #1, is shown as a control with a stable surface tension over time (or surface age in milliseconds) between 70 and 80 mN/m. The identified composition of 1% PFAS/fluorinated surfactant in deionized water represents surface tension values between 20-50 mN/m over time (or surface age in milliseconds). The PFAS surfactants may be considered benchmarks (and are marked as BM #1, BM #2, etc.) for the purposes of the experimentation results, as the known performance of the PFAS/fluorinated surfactants in applications may be desirable to emulate. However, due to the hazardous nature of the PFAS/fluorinated surfactants, it may be desired to remove these PFAS/fluorinated substances from the composition.

Various experiments were performed using a mixture of trisiloxane surfactants and silicone compatibilizers. The use of trisiloxane surfactants alone may only approach the surface tension values of the PFAS/fluorinated surfactants gradually as time elapses. As shown in FIG. 1, some compositions with 1% of the trisiloxane surfactant in deionized water (labeled as C #2-C #7) reached an appropriate level of surface tension of PFAS/fluorinated surfactants (i.e., BM #1 and BM #2) at about 700 ms, except for C #2 at about 4000 ms.

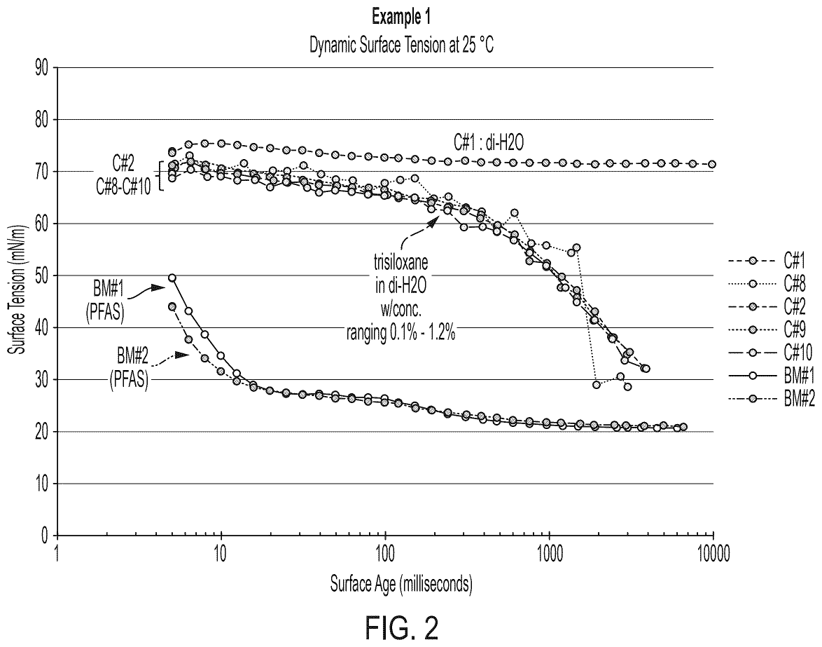

FIG. 2 illustrates a comparison between trisiloxane surfactants and fluorinated surfactants. Two prior art fluorinated surfactants (Tivida FL2300 and FS-30) are shown. The trisiloxane surfactant used in this experiment was Silsurf A004-UP. FIG. 2 illustrates that, the trisiloxane surfactant of Silsurf A004-UP alone in the range of 0.1 and 1.2% (i.e., C #2 and C #8-C #10) in deionized water presented a stiff challenge to bring the surface tension values down to the level comparable to PFAS/fluorinated surfactants (BM #1 and BM #2) could reach over time at different stage of surface age (in millisecond).

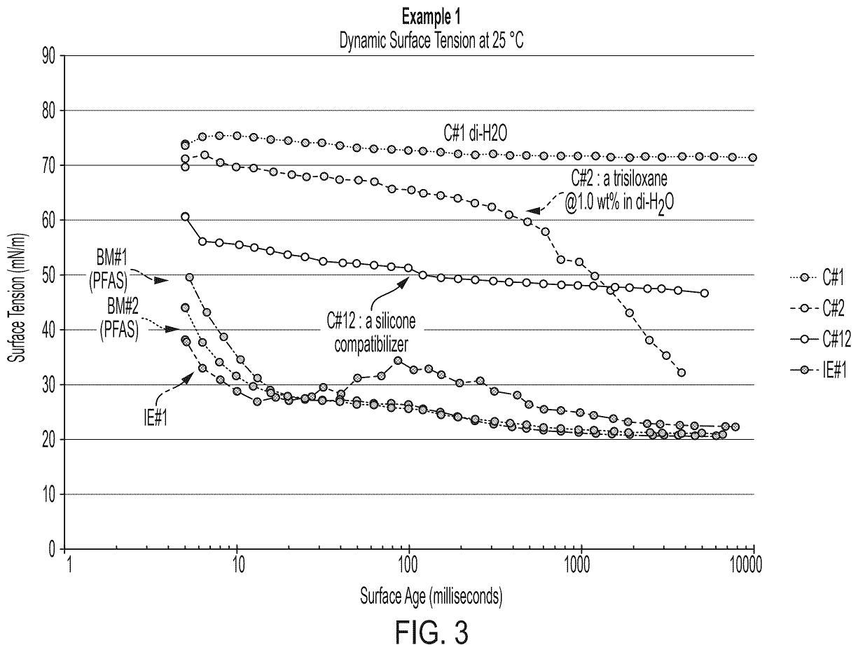

FIG. 3 shows a similar comparison, however, instead of trying to vary the amount of trisiloxane surfactant (C #2), a silicone compatibilizer is utilized. The inclusion of the silicone compatibilizer (C #12) by itself at 0.25% in deionized water reduced the surface tension noticeably, relative to the deionized water. However, the combination of trisiloxane surfactant (C #2) and silicone compatibilizer (C #12) resulted in both (1) a drastic reduction of the surface tension relative to C #2 and C #12, and (2) a reduction in surface tension down to the level achieved by PFAS/fluorinated surfactants (BM #1 and BM #2)

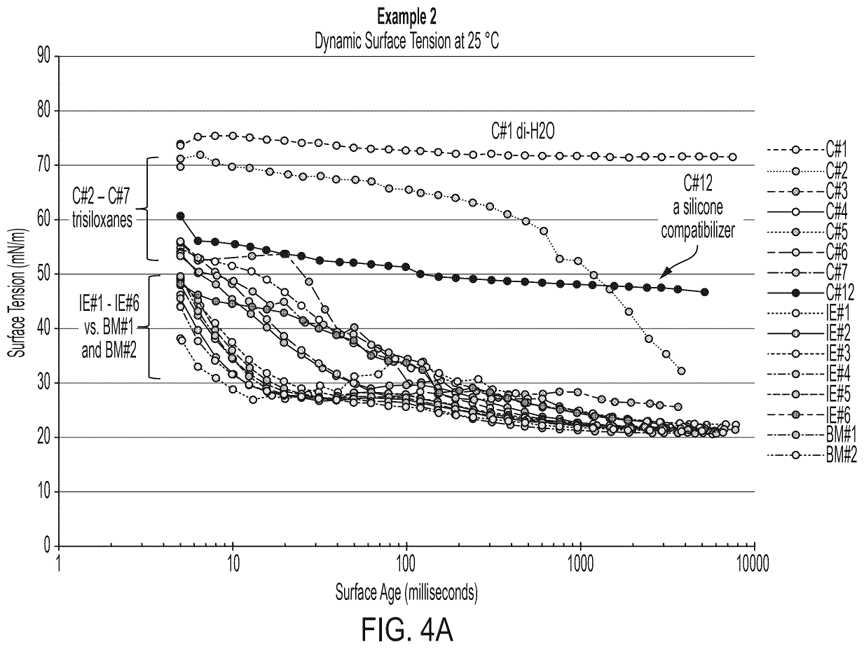

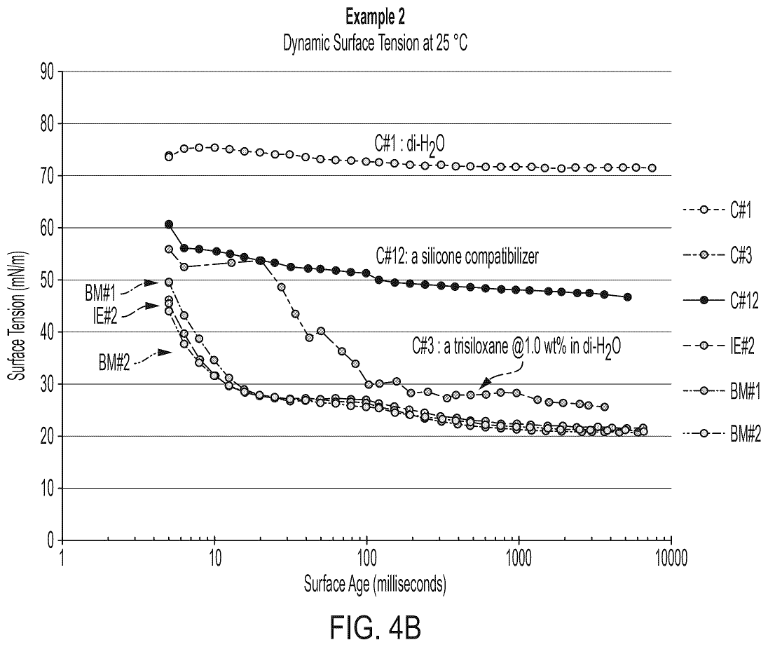

FIG. 4A illustrates an experiment showing the changes and trends of surface tension over time of a variety of trisiloxane surfactants by themselves (C #2-C #7) from different suppliers/manufacturers and the use of a combination (IE #2-IE #6) of trisiloxane surfactants (C #2-C #7) and silicone compatibilizer (C #12). The combinations of trisiloxane surfactant and silicone compatibilizer (IE #2-IE #6) could also bring their respective surface tension down quickly to the range where IE #1, BM #1 and BM #2 reside (as can be seen in FIG. 3).

In FIG. 4B, the dynamic surface tension over time (or surface age in milliseconds) with the combination of a trisiloxane surfactant (C #3) and a silicone compatibilizer (C #12), i.e., IE #2, illustrates the effectiveness of lowering the surface tension to levels similar to that of the PFAS/fluorinated surfactants (BM #1 and BM #2).

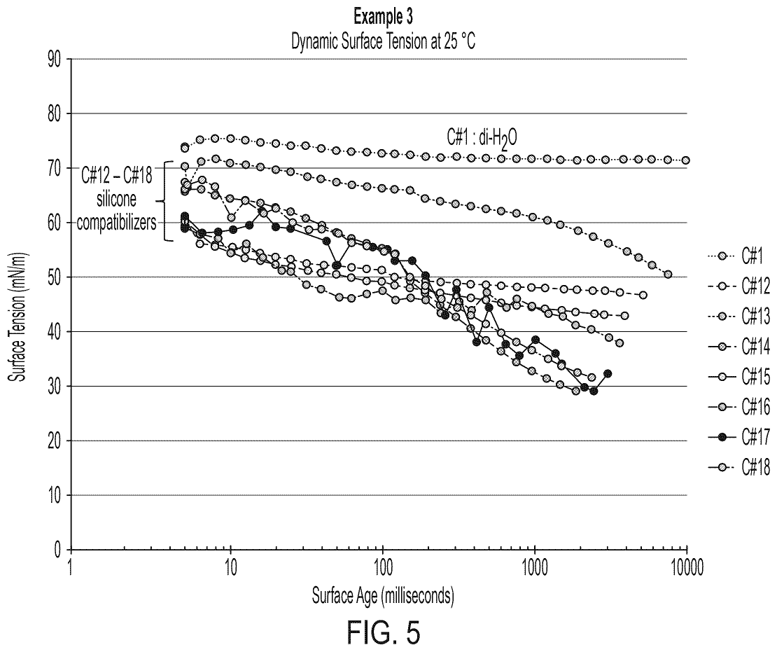

FIG. 5 shows a comparison of dynamic surface tension over time (or surface age in milliseconds) for a variety of silicone compatibilizers (C #12-C #18). Similar to C #12 (referring to FIGS. 3 and 4A), the silicone compatibilizers (C #13-C #18) may also lower the surface tension relative to deionized water, however, they may not reach the surface tension to the levels similar to that of the combinations or mixtures of trisiloxane and silicone compatibilizer, as demonstrated in FIGS. 3, 4A, and 4B.

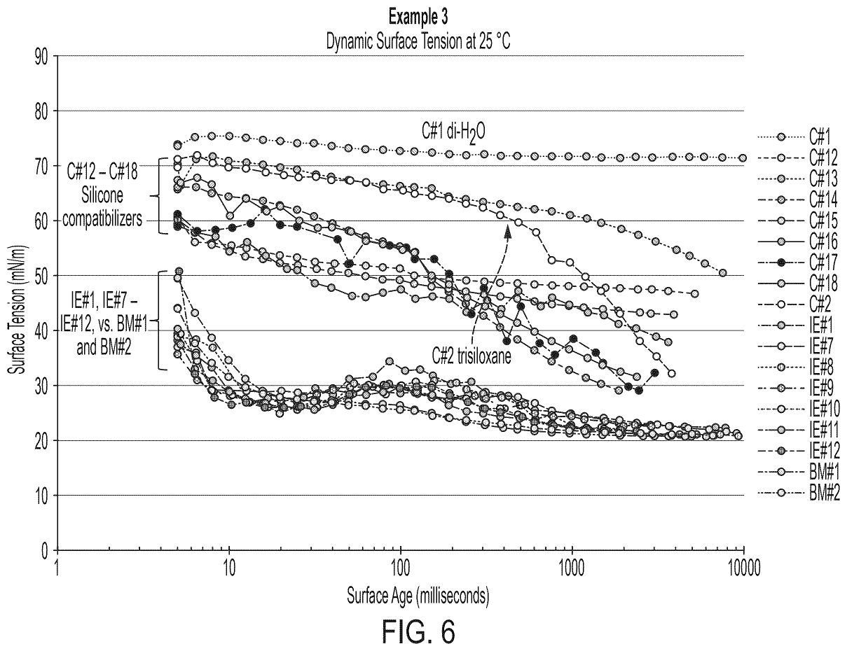

FIG. 6 illustrates examples of a trisiloxane surfactant (C #2) in combination with various silicone compatibilizers (C #12-C #18). In this example, the trisiloxane surfactant concentration was maintained at 1% in deionized water and the silicone compatibilizer concentrations were kept at 0.25%. All the combinations of C #2 with C #13-C #18, respectively, exhibited combined embodiments (i.e., IE #7-IE #12) with very comparable dynamic surface tension over time (or surface age in milliseconds) compared to IE #1 (i.e., the combination of trisiloxane surfactant C #2 and silicone compatibilizer C #12) and the PFAS/fluorinated surfactants.

FIG. 6 illustrates examples of a single trisiloxane surfactant (C #2) in combination with various silicone compatibilizers (C #12-C #18). However, when combined with the trisiloxane surfactant (labeled as IE #1, IE #7-IE #12), the surface tension values are reduced to as good or better than traditional fluorinated surfactants (BM #1 and BM #2). These tests maintained the concentration of the trisiloxane surfactant at 1% and the silicone compatibilizer concentration at 0.25%. All of these combinations exhibited superior properties in comparison to the fluorinated surfactants, which are also shown, in being able to achieve and maintain sufficiently low surface tensions over time.

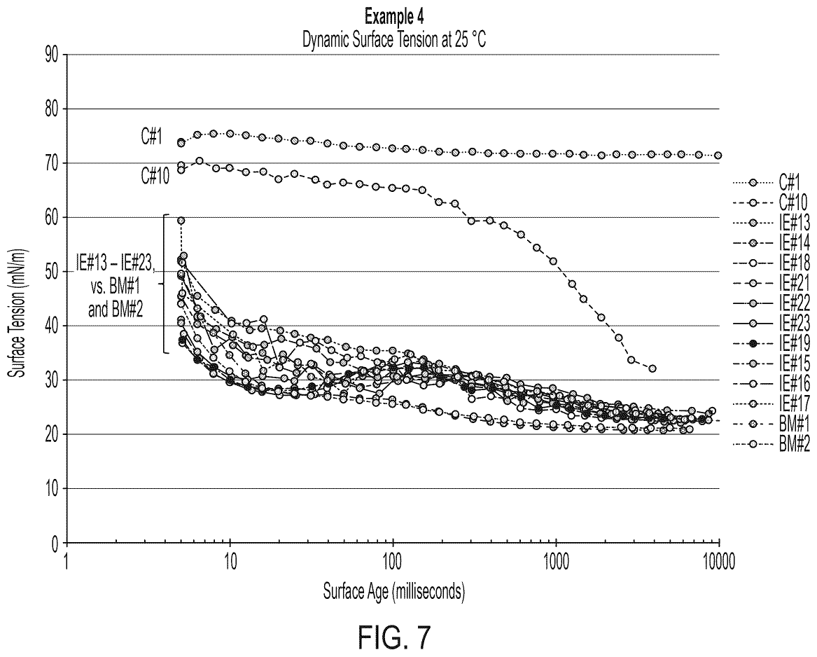

FIG. 7 illustrates combinations of Silsurf A004-UP trisiloxane surfactant and silicone compatibilizer (C #12) in various amounts at various weight ratios (IE #13-IE #23). All of the combinations (IE #13-IE #23) could effectively lower the surface tension. However, there were various ranges of amounts of trisiloxane surfactant and weight ratios of silicone compatibilizer-to-trisiloxane surfactant (i.e., Silsurf A004-UP trisiloxane surfactant amounts from 0.8%-1.2% and the weight ratio of silicone compatibilizer-to-trisiloxane surfactant from approximately 22 wt % up to approximately 100 wt %, shown as IE #18-IE #23), where the dynamic surface tensions over time (or surface age in milliseconds) were most comparable to the PFAS/fluorinated surfactants (BM #1 and BM #2).

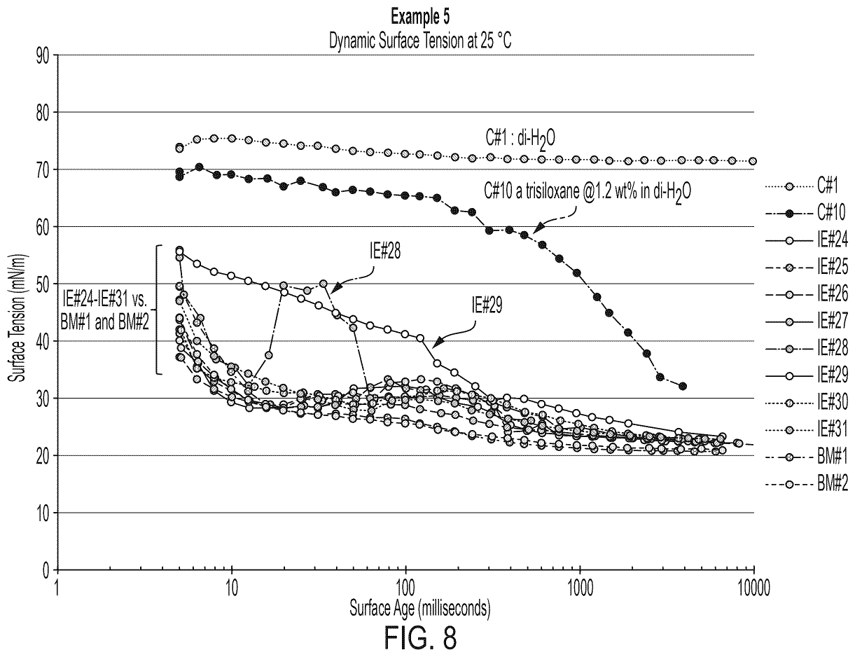

FIG. 8 illustrates combinations of trisiloxane surfactant (C #10 at 1.2% in deionized water) and a variety of silicone compatibilizers (for instance, BYK3455, Siltech C-570, Silsurf A208, TegoGlide 496) in various amounts at various weight ratios (IE #13-IE #23). All the combinations (IE #24-IE #31) could effectively lower the dynamic surface tension over time (or surface age in milliseconds). There was a range of weight ratio of silicone compatibilizer-to-trisiloxane surfactant, i.e., the weight ratio of silicone compatibilizers (C #15-C #17) to trisiloxane surfactant (C #10), of more than 21 wt % (IE #24-IE #27, IE #30, and IE #31), where the dynamic surface tensions over time (or surface age in milliseconds) were most comparable to the PFAS/fluorinated surfactants (BM #1 and BM #2). The range of weight ratios of Silsurf A208 silicone compatibilizers to trisiloxane surfactant may be required to be less than 24 wt % (such as IE #28-IE #29) to obtain a comparable dynamic surface tension over time (or surface age in milliseconds) that is closer to the dynamic surface tension over time of IE #24-IE #27 and IE #30-IE #31.

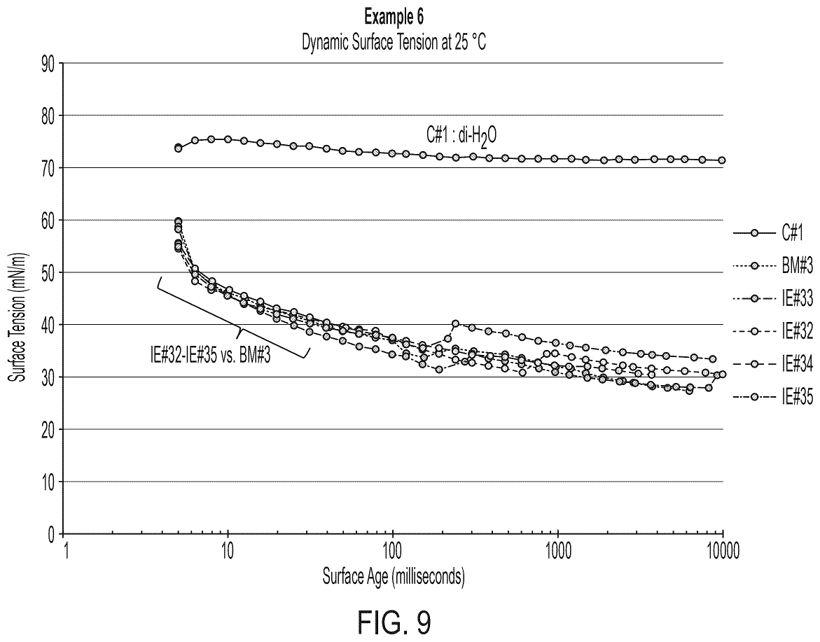

FIG. 9 illustrates the dynamic surface tension over time (or surface age in milliseconds) of: (1) aqueous dispersions of thermal dye-receiving layers comprising a trisiloxane surfactant, a silicone compatibilizer, and a Siltech E-2150 LT release agent employing low tin-catalyst (i.e., IE #32-IE #35); and (2) an aqueous dispersion of thermal dye-receiving layer comprising a perfluorinated PFAS surfactant Tivida FL2300 and Siltech E-2150 LT release agent employing low tin-catalyst (i.e., BM #3). In FIG. 9, the aqueous dispersions of the embodiments IE #32-IE #35 exhibited that dynamic surface tensions over time (or surface age in milliseconds) comparable to that of BM #3, particularly in the time frame of surface age between approximately 5-100 milliseconds. As a result, glossy, smooth, and uniform DRL coatings were produced on a pilot coating machine at a coating speed of at least approximately 150 mpm. Furthermore, IE #32-IE #35 may exhibit excellent printing performance during thermal printing process and high-quality prints may be obtained, as compared to BM #3. Each chemical formulation may be present in a single thermal DRL, but it should be appreciated that there may also be two or more layers. Also, each chemical formulation shown in FIG. 9 may contain substantially all the components listed in Table 1 above (such as binders, dispersants, etc.).

The image-receiving layer may be a single-layer DRL or may be a bi-layer configuration (i.e., a receiver overcoat (ROC) on top of a DRL), as described in U.S. Pat. No. 9,707,788. The image-receiving layer may be coated on one or both opposing sides of the support substrate, allowing for thermal dye transfer imaging on either or both sides of the thermal receiver sheet, as is also described in U.S. Pat. No. 9,707,788.

### EXAMPLES

### Example 0

Control Example—measuring Surface Tension at various Surface Ages of commercially available trisiloxane surfactants, deionized water, and PFAS/fluorinated surfactant benchmarks. Table 2 data is displayed in the figures as FIG. 1. In the dynamic surface tension measurements, Krüss BP2 MKII Bubble Pressure Tensiometer was employed, using a Teflon tip with a tip diameter of approximately 0.529 mm, and sample temperature was kept at approximately 25° C.

TABLE 2

| | | | | Dynamic Surface Tension (mN/m) | | | | |
|---|---|---|---|---|---|---|---|---|
| | Composition Description | | | Surface | Surface | Surface | Surface | Surface |
| Sample | | Surfactant | Surfactant | Age | Age | Age | Age | Age |
| ID# | Surfactant | type | wt % | 5 ms | 10 ms | 50 ms | 100 ms | 1500 ms |
| C#1 | di-H2O | — | — | 73.9 | 75.4 | 73.2 | 72.7 | 71.5 |
| C#2 | Silsurf | trisiloxane | 1.0 | 69.7 | 69.7 | 67.3 | 65.5 | 46.9 |
| | A004-UP | | | | | | | |
| C#3 | Silsurf | trisiloxane | 1.0 | 55.9 | 53.3 | 40.2 | 30.5 | 26.6 |
| | A008-UP | | | | | | | |
| C#4 | CoatOSil- | trisiloxane | 1.0 | 55.6 | 51.5 | 37.3 | 33.1 | 23.5 |
| | 7608 | | | | | | | |
| C#5 | CoatOSil- | trisiloxane | 1.0 | 54.1 | 51.5 | 29.8 | 29.6 | 22.1 |
| | 77 | | | | | | | |
| C#6 | BYK-3450 | trisiloxane | 1.0 | 55.8 | 48.2 | 30.0 | 27.7 | 21.7 |
| C#7 | BYK-3451 | trisiloxane | 1.0 | 53.3 | 48.7 | 38.9 | 34.4 | 23.6 |
| BM#1 | Tivida | PFAS | 1.0 | 49.5 | 34.6 | 27.1 | 26.4 | 21.0 |
| | FL2300 | | | | | | | |
| BM#2 | Capstone | PFAS | 1.0 | 44.1 | 31.6 | 26.4 | 25.6 | 21.5 |
| | FS-30 | | | | | | | |

### Example 1

The use of trisiloxane surfactant in deionized water as a wetting and spreading agent by itself in contrast to the use of a trisiloxane surfactant in combination with a silicone compatibilizer on lowering the dynamic surface tension over time (or surface age in milliseconds) effectively. Table 3 data is displayed in the figures as FIG. 2. Table 4 data is displayed in the figures as FIG. 3.

TABLE 3

| | | | | Dynamic Surface Tension (mN/m) | | | | |
|---|---|---|---|---|---|---|---|---|
| | Composition Description | | | Surface | Surface | Surface | Surface | Surface |
| Sample | | Surfactant | Trisiloxane | Age | Age | Age | Age | Age |
| ID# | Surfactant | type | wt % | 5 ms | 10 ms | 50 ms | 100 ms | 1500 ms |
| C#1 | di-H2O | — | — | 73.9 | 75.4 | 73.2 | 72.7 | 71.5 |
| C#8 | Silsurf | trisiloxane | 0.1 | 71.5 | 70.1 | 68.5 | 67.8 | 53.5 |
| | A004-UP | | | | | | | |
| C#9 | Silsurf | trisiloxane | 0.8 | 70.1 | 70.6 | 67.3 | 66.4 | 45.5 |
| | A004-UP | | | | | | | |
| C#2 | Silsurf | trisiloxane | 1.0 | 69.7 | 69.7 | 67.3 | 65.5 | 46.9 |
| | A004-UP | | | | | | | |
| C#10 | Silsurf | trisiloxane | 1.2 | 69.6 | 69.1 | 66.4 | 65.4 | 44.6 |
| | A004-UP | | | | | | | |
| BM#1 | Tivida | PFAS | 1.0 | 49.5 | 34.6 | 27.1 | 26.4 | 21.0 |
| | FL2300 | | | | | | | |
| BM#2 | Capstone | PFAS | 1.0 | 44.1 | 31.6 | 26.4 | 25.6 | 21.5 |
| | FS-30 | | | | | | | |

TABLE 4

| | Composition Description | | | | Dynamic Surface Tension (mN/m) | | | | |
|---|---|---|---|---|---|---|---|---|---|
| | | Trisil- | | Compati- | Surface | Surface | Surface | Surface | Surface |
| Sample | | oxane | Compati- | bilizer | Age | Age | Age | Age | Age |
| ID# | Trisiloxane | wt % | bilizers | wt % | 5 ms | 10 ms | 50 ms | 100 ms | 1500 ms |
| C#1 | di-H2O | — | — | — | 73.9 | 75.4 | 73.2 | 72.7 | 71.5 |
| C#2 | Silsurf | 1.0 | n/a | 0 | 69.7 | 69.7 | 67.3 | 65.5 | 46.9 |
| | A004-UP | | | | | | | | |
| C#12 | n/a | 0 | Silsurf | 0.25 | 60.7 | 55.5 | 52.1 | 51.2 | 47.8 |
| | | | Q25315-O | | | | | | |
| IE#1 | Silsurf | 1.0 | Silsurf | 0.25 | 38.2 | 28.8 | 31.2 | 33.2 | 23.8 |
| | A004-UP | | Q25315-O | | | | | | |
| BM#1 | Tivida | 1.0 | n/a | 0 | 49.5 | 34.6 | 27.1 | 26.4 | 21.0 |
| | FL2300 | | | | | | | | |
| BM#2 | Capstone | 1.0 | n/a | 0 | 44.1 | 31.6 | 26.4 | 25.6 | 21.5 |
| | FS-30 | | | | | | | | |

### Example 2

The combinations of a variety of trisiloxane surfactants and silicone compatibilizers on lowering the dynamic surface tension over time (or surface age in milliseconds) effectively. Table 5 data is displayed in the figures as FIGS. 4A and 4B.

TABLE 5

| | Composition Description | | | | Dynamic Surface Tension (mN/m) | | | | |
|---|---|---|---|---|---|---|---|---|---|
| | | Trisil- | | Compati- | Surface | Surface | Surface | Surface | Surface |
| Sample | | oxane | Compati- | bilizer | Age | Age | Age | Age | Age |
| ID# | Trisiloxane | wt % | bilizers | wt % | 5 ms | 10 ms | 50 ms | 100 ms | 1500 ms |
| C#1 | di-H2O | n/a | n/a | n/a | 73.9 | 75.4 | 73.2 | 72.7 | 71.5 |
| C#2 | Silsurf | 1.0 | n/a | 0 | 69.7 | 69.7 | 67.3 | 65.5 | 46.9 |
| | A004-UP | | | | | | | | |
| C#3 | Silsurf | 1.0 | n/a | 0 | 55.9 | 53.3 | 40.2 | 30.5 | 26.6 |
| | A008-UP | | | | | | | | |
| C#4 | CoatOSil- | 1.0 | n/a | 0 | 55.6 | 51.5 | 37.3 | 33. | 23.5 |
| | 7608 | | | | | | | | |
| C#5 | CoatOSil-77 | 1.0 | n/a | 0 | 54.1 | 51.5 | 29.8 | 29.6 | 22.1 |
| C#6 | BYK-3450 | 1.0 | n/a | 0 | 55.8 | 48.2 | 30.0 | 27.7 | 21.7 |
| C#7 | BYK-3451 | 1.0 | n/a | 0 | 53.3 | 48.7 | 38.9 | 34.4 | 23.6 |
| C#12 | n/a | 0 | Silsurf | 0.25 | 60.7 | 55.5 | 52.1 | 51.2 | 47.8 |
| | | | Q25315-O | | | | | | |
| IE#1 | Silsurf | 1.0 | Silsurf | 0.25 | 38.2 | 28.8 | 31.2 | 33.2 | 23.8 |
| | A004-UP | | Q25315-O | | | | | | |
| IE#2 | Silsurf | 1.0 | Silsurf | 0.25 | 46.2 | 31.6 | 27.1 | 27.0 | 22.0 |
| | A008-UP | | Q25315-O | | | | | | |
| IE#3 | CoatOSil- | 1.0 | Silsurf | 0.25 | 49.3 | 37.5 | 28.2 | 27.9 | 22.2 |
| | 7608 | | Q25315-O | | | | | | |
| IE#4 | CoatOSil- | 1.0 | Silsurf | 0.25 | 48.0 | 34.4 | 28.2 | 27.9 | 22.1 |
| | 77 | | Q25315-O | | | | | | |
| IE#5 | BYK-3450 | 1.0 | Silsurf | 0.25 | 48.9 | 36.0 | 27.5 | 27.3 | 21.8 |
| | | | Q25315-O | | | | | | |
| IE#6 | BYK-3451 | 1.0 | Silsurf | 0.25 | 48.2 | 44.5 | 37.8 | 33.7 | 23.5 |
| | | | Q25315-O | | | | | | |
| BM#1 | Tivida | 1.0 | n/a | 0 | 49.5 | 34.6 | 27.1 | 26.4 | 21.0 |
| | FL2300 | | | | | | | | |
| BM#2 | Capstone | 1.0 | n/a | 0 | 44.1 | 31.6 | 26.4 | 25.6 | 21.5 |
| | FS-30 | | | | | | | | |

### Example 3

The effect of a variety of silicone compatibilizers on lowering the dynamic surface tension over time (or surface age in milliseconds). Table 6 data is displayed in the figures as FIG. 5. Table 7 data is displayed in the figures as FIG. 6.

TABLE 6

| | Composition Description | | Dynamic Surface Tension (mN/m) | | | | |
|---|---|---|---|---|---|---|---|
| | | Compati- | Surface | Surface | Surface | Surface | Surface |
| Sample | Compati- | bilizer | Age | Age | Age | Age | Age |
| ID# | bilizers | wt % | 5 ms | 10 ms | 50 ms | 100 ms | 1500 ms |
| C#1 | di-H2O | — | 73.9 | 75.4 | 73.2 | 72.7 | 71.5 |
| C#12 | Silsurf | 0.25 | 60.7 | 55.5 | 52.1 | 51.2 | 47.8 |
| | Q25315-O | | | | | | |
| C#13 | Silsurf | 0.25 | 70.3 | 70.9 | 67.4 | 66.3 | 59.5 |
| | Q20308 | | | | | | |
| C#14 | Silsurf | 0.25 | 65.7 | 64.4 | 58.2 | 55.2 | 30.2 |
| | A208 | | | | | | |
| C#15 | Tego Glide | 0.25 | 59.4 | 54.5 | 50.5 | 49.2 | 43.9 |
| | 496 | | | | | | |
| C#16 | BYK-3455 | 0.25 | 58.9 | 54.4 | 46.3 | 47.5 | 42.8 |
| C#17 | Siltech | 0.25 | 59.0 | 58.7 | 52.2 | 55.2 | 34.2 |
| | C-570 | | | | | | |
| C#18 | Tego Twin | 0.25 | 67.4 | 60.9 | 58.0 | 54.8 | 33.7 |
| | 4100 | | | | | | |
| BM#1 | n/a | n/a | 49.5 | 34.6 | 27.1 | 26.4 | 21.0 |
| BM#2 | n/a | n/a | 44.1 | 31.6 | 26.4 | 25.6 | 21.5 |

TABLE 7

| | Composition Description | | | | Dynamic Surface Tension (mN/m) | | | | |
|---|---|---|---|---|---|---|---|---|---|
| | | Trisil- | | Compati- | Surface | Surface | Surface | Surface | Surface |
| Sample | | oxane | Compati- | bilizer | Age | Age | Age | Age | Age |
| ID# | Trisiloxane | wt % | bilizers | wt % | 5 ms | 10 ms | 50 ms | 100 ms | 1500 ms |
| C#1 | di-H2O | — | — | — | 73.9 | 75.4 | 73.2 | 72.7 | 71.5 |
| C#2 | Silsurf | 1.0 | n/a | 0 | 69.7 | 69.7 | 67.3 | 65.5 | 46.9 |
| | A004-UP | | | | | | | | |
| IE#1 | Silsurf | 1.0 | Silsurf | 0.25 | 38.2 | 28.8 | 31.2 | 33.2 | 23.8 |
| | A004-UP | | Q25315-O | | | | | | |
| IE#7 | Silsurf | 1.0 | Silsurf | 0.25 | 37.0 | 29.1 | 29.7 | 29.9 | 24.1 |
| | A004-UP | | Q20308 | | | | | | |
| IE#8 | Silsurf | 1.0 | Silsurf | 0.25 | 39.4 | 31.95 | 30.4 | 29.7 | 22.4 |
| | A004-UP | | A208 | | | | | | |
| IE#9 | Silsurf | 1.0 | Tego | 0.25 | 35.7 | 28.1 | 28.5 | 29.5 | 23.5 |
| | A004-UP | | Glide | | | | | | |
| | | | 496 | | | | | | |
| IE#10 | Silsurf | 1.0 | BYK-3455 | 0.25 | 39.4 | 28.3 | 27.1 | 30.0 | 22.1 |
| | A004-UP | | | | | | | | |
| IE#11 | Silsurf | 1.0 | Siltech | 0.25 | 40.3 | 28.9 | 28.1 | 28.6 | 21.7 |
| | A004-UP | | C-570 | | | | | | |
| IE#12 | Silsurf | 1.0 | TegoTwin | 0.25 | 50.8 | 26.5 | 28.4 | 29.5 | 21.8 |
| | A004-UP | | 4100 | | | | | | |
| BM#1 | Tivida | 1.0 | n/a | 0 | 49.5 | 34.6 | 27.1 | 26.4 | 21.0 |
| | FL2300 | | | | | | | | |
| BM#2 | Capstone | 1.0 | n/a | 0 | 44.1 | 31.6 | 26.4 | 25.6 | 21.5 |
| | FS-30 | | | | | | | | |

### Example 4

The effect of more preferred compatibilizer dosage levels and more preferred weight ratios of silicone compatibilizer-to-trisiloxane surfactant on dynamic surface tension. Table 8 data is displayed in the figures as FIG. 7. It should be noted that the weight ratio of silicone compatibilizer-to-trisiloxane surfactant is displayed as wt % of “Compatibilizer/Trisiloxane” in Table 8.

TABLE 8

| | Composition Description | | | | | | | | | |
|---|---|---|---|---|---|---|---|---|---|---|
| | | | | | Compati- | Dynamic Surface Tension (mN/m) | | | | |
| | | Trisil- | | Compati- | bilizer/ | Surface | Surface | Surface | Surface | Surface |
| Sample | Trisil- | oxane | Compati- | bilizer | Trisil- | Age | Age | Age | Age | Age |
| ID# | oxane | wt % | bilizers | wt % | oxane % | 5 ms | 10 ms | 50 ms | 100 ms | 1500 ms |
| C#1 | di- | n/a | n/a | n/a | n/a | 73.9 | 75.4 | 73.2 | 72.7 | 71.5 |
| | H2O | | | | | | | | | |
| C#10 | Silsurf | 1.2 | Silsurf | 0 | n/a | 69.6 | 69.1 | 66.4 | 65.4 | 44.6 |
| | A004- | | Q25315- | | | | | | | |
| | UP | | O | | | | | | | |
| IE#13 | Silsurf | 1.2 | Silsurf | 0.1 | 8% | 52.2 | 40.9 | 36.1 | 35.4 | 25.9 |
| | A004- | | Q25315- | | | | | | | |
| | UP | | O | | | | | | | |
| IE#14 | Silsurf | 1.2 | Silsurf | 0.25 | 21% | 45.4 | 36.4 | 30.0 | 29.6 | 25.3 |
| | A004- | | Q25315- | | | | | | | |
| | UP | | O | | | | | | | |
| IE#15 | Silsurf | 1.4 | Silsurf | 0.29 | 21% | 52.9 | 36.4 | 33.2 | 31.6 | 26.8 |
| | A004- | | Q25315- | | | | | | | |
| | UP | | O | | | | | | | |
| IE#16 | Silsurf | 1.6 | Silsurf | 0.33 | 21% | 51.8 | 40.4 | 34.1 | 33.2 | 25.4 |
| | A004- | | Q25315- | | | | | | | |
| | UP | | O | | | | | | | |
| IE#17 | Silsurf | 2.0 | Silsurf | 0.42 | 21% | 59.4 | 38.4 | 27.5 | 33.6 | 25.6 |
| | A004- | | Q25315- | | | | | | | |
| | UP | | O | | | | | | | |
| IE#18 | Silsurf | 1.2 | Silsurf | 0.275 | 23% | 36.8 | 29.6 | 30.1 | 31.8 | 23.4 |
| | A004- | | Q25315- | | | | | | | |
| | UP | | O | | | | | | | |
| IE#19 | Silsurf | 1.4 | Silsurf | 0.322 | 23% | 37.4 | 30.0 | 31.1 | 32.3 | 23.9 |
| | A004- | | Q25315- | | | | | | | |
| | UP | | O | | | | | | | |
| IE#20 | Silsurf | 0.8 | Silsurf | 0.192 | 24% | 36.5 | 29.3 | 30.5 | 30.2 | 23.8 |
| | A004- | | Q25315- | | | | | | | |
| | UP | | O | | | | | | | |
| IE#1 | Silsurf | 1.0 | Silsurf | 0.25 | 25% | 38.2 | 28.8 | 31.2 | 33.2 | 23.8 |
| | A004- | | Q25315- | | | | | | | |
| | UP | | O | | | | | | | |
| IE#21 | Silsurf | 1.2 | Silsurf | 0.4 | 33% | 38.5 | 29.6 | 31.0 | 32.5 | 24.6 |
| | A004- | | Q25315- | | | | | | | |
| | UP | | O | | | | | | | |
| IE#22 | Silsurf | 1.2 | Silsurf | 0.6 | 50% | 49.2 | 37.9 | 29.9 | 30.7 | 24.5 |
| | A004- | | Q25315- | | | | | | | |
| | UP | | O | | | | | | | |
| IE#23 | Silsurf | 1.2 | Silsurf | 1.2 | 100% | 41.1 | 30.6 | 29.3 | 29.9 | 24.7 |
| | A004- | | Q25315- | | | | | | | |
| | UP | | O | | | | | | | |

### Example 5

The weight ratio of “a variety of silicone compatibilizers to trisiloxane surfactant” on dynamic surface tension over time (or surface age in milliseconds). Table 9 data is displayed in the figures as FIG. 8. It should be noted that weight ratio of “a variety of silicone compatibilizers to trisiloxane surfactant” is displayed as wt % of “Compatibilizer/Trisiloxane” in Table 9.

TABLE 9

| | Composition Description | | | | | | | | | |
|---|---|---|---|---|---|---|---|---|---|---|
| | | | | | Compati- | Dynamic Surface Tension (mN/m) | | | | |
| | | Trisil- | | Compati- | bilizer/ | Surface | Surface | Surface | Surface | Surface |
| Sample | Trisil- | oxane | Compati- | bilizer | Trisil- | Age | Age | Age | Age | Age |
| ID# | oxane | wt % | bilizers | wt % | oxane % | 5 ms | 10 ms | 50 ms | 100 ms | 1500 ms |
| C#1 | di-H2O | n/a | n/a | n/a | n/a | 73.9 | 75.4 | 73.2 | 72.7 | 71.5 |
| C#10 | Silsurf | 1.2 | Silsurf | 0 | n/a | 69.6 | 69.1 | 66.4 | 65.4 | 44.6 |
| | A004-UP | | Q25315-O | | | | | | | |
| IE#14 | Silsurf | 1.2 | Silsurf | 0.25 | 21% | 45.4 | 36.4 | 30.0 | 29.6 | 25.3 |
| | A004-UP | | Q25315-O | | | | | | | |
| IE#21 | Silsurf | 1.2 | Silsurf | 0.4 | 33% | 38.5 | 29.6 | 31.0 | 32.5 | 24.6 |
| | A004-UP | | Q25315-O | | | | | | | |
| IE#23 | Silsurf | 1.2 | Silsurf | 1.2 | 100% | 41.1 | 30.6 | 29.3 | 29.9 | 24.7 |
| | A004-UP | | Q25315-O | | | | | | | |
| IE#24 | Silsurf | 1.2 | BYK | 0.25 | 21% | 40.1 | 29.3 | 31.7 | 32.1 | 23.3 |
| | A004-UP | | 3455 | | | | | | | |
| IE#25 | Silsurf | 1.2 | BYK- | 0.5 | 42% | 42.0 | 29.6 | 29.9 | 31.7 | 23.1 |
| | A004-UP | | 3455 | | | | | | | |
| IE#26 | Silsurf | 1.2 | BYK- | 0.55 | 46% | 43.7 | 29.6 | 31.0 | 32.9 | 23.1 |
| | A004-UP | | 3455 | | | | | | | |
| IE#27 | Silsurf | 1.2 | Siltech | 0.6 | 50% | 37.2 | 30.2 | 28.9 | 28.8 | 23.3 |
| | A004-UP | | C-570 | | | | | | | |
| IE#28 | Silsurf | 1.2 | Silsurf | 0.29 | 24% | 54.6 | 35.3 | 42.3 | 30.1 | 23.8 |
| | A004-UP | | A208 | | | | | | | |
| IE#29 | Silsurf | 1.2 | Silsurf | 1.2 | 100% | 55.9 | 51.4 | 43.8 | 41.2 | 26.2 |
| | A004-UP | | A208 | | | | | | | |
| IE#30 | Silsurf | 1.2 | TegoGlide | 0.25 | 21% | 41.9 | 32.8 | 28.9 | 30.3 | 24.2 |
| | A004-UP | | 496 | | | | | | | |
| IE#31 | Silsurf | 1.2 | TegoGlide | 3 | 250% | 47.2 | 35.5 | 28.0 | 29.7 | 23.7 |
| | A004-UP | | 496 | | | | | | | |
| BM#1 | Tivida | 1.0 | n/a | n/a | n/a | 49.5 | 34.6 | 27.1 | 26.4 | 21.0 |
| | FL2300 | | | | | | | | | |
| BM#2 | Capstone | 1.0 | n/a | n/a | n/a | 44.1 | 31.6 | 26.4 | 25.6 | 21.5 |
| | FS-30 | | | | | | | | | |

### Example 6

The use of trisiloxane surfactant and silicone compatibilizer in dye-receiving layer of thermal dye transfer receiving elements. Table 10 data is displayed in the figures as FIG. 9.

TABLE 10

| | Composition Description | | | | Dynamic Surface Tension (mN/m) | | | | |
|---|---|---|---|---|---|---|---|---|---|
| | | | | Compati- | Surface | Surface | Surface | Surface | Surface |
| Sample | | Surfactant | Compati- | bilizer | Age | Age | Age | Age | Age |
| ID# | Surfactant | wt % | bilizer | wt % | 5 ms | 10 ms | 50 ms | 100 ms | 1500 ms |
| C#1 | n/a | n/a | n/a | n/a | 73.9 | 75.4 | 73.2 | 72.7 | 71.5 |
| BM#3 | Tivida | 0.85 | n/a | n/a | 59.8 | 46.1 | 38.7 | 36.8 | 30.6 |
| | FL2300 | | | | | | | | |
| IE#32 | Silsurf | 1 | Silsurf | 0.25 | 54.5 | 45.8 | 39.6 | 37.3 | 31.8 |
| | A004-UP | | Q25315- | | | | | | |
| | | | O | | | | | | |
| IE#33 | Silsurf | 1.2 | Silsurf | 0.25 | 58.7 | 45.6 | 36.9 | 34.3 | 29.8 |
| | A004-UP | | Q25315- | | | | | | |
| | | | O | | | | | | |
| IE#34 | BYK- | 1.2 | Silsurf | 0.25 | 55.6 | 46.6 | 39.4 | 37.4 | 32.0 |
| | 3450 | | Q25315- | | | | | | |
| | | | O | | | | | | |
| IE#35 | CoatOSil- | 1.2 | Silsurf | 0.25 | 55.4 | 45.5 | 39.4 | 37.5 | 35.6 |
| | 77 | | Q25315- | | | | | | |
| | | | O | | | | | | |

Although the technology herein has been described with reference to embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A composition for a thermal receiver element, comprising:
a trisiloxane surfactant comprising at least one of an ethoxylated polydimethylsiloxane, a distillate from a mono-functional trisiloxane intermediate, or a polyether-modified siloxane; and
a silicone compatibilizer comprising at least one of a silicone polyether, a silicone glycol copolymer, an organo-modified silicone that is dispersible in water, a siloxane-based Gemini surfactant, a polyether siloxane copolymer, or a polyether-modified polydimethylsiloxane.

2. The composition of claim 1, further comprising:
a static control agent, wherein the static control agent comprises poly (3,4-ethylenedioxythiophene) polystyrene sulfonate (PEDOT: PSS).

3. The composition of claim 1, further comprising:
a first dispersant and a second dispersant.

4. The composition of claim 1, further comprising:
a crosslinker.

5. The composition of claim 4, wherein the crosslinker comprises a polycarbodiimide based crosslinking agent with a hydrophilic segment.

6. The composition of claim 1, further comprising:
a film former, wherein the film former comprises a water-dispersible polyester binder.

7. The composition of claim 1, further comprising:
a release agent.

8. The composition of claim 7, wherein the release agent comprises water-dispersible polyoxyalkylene-modified dimethylsiloxane graft copolymers having at least one alkylene oxide pendant chain.

9. The composition of claim 1, further comprising:
a dye-receiving layer (DRL) latex binder.

10. The composition of claim 1, further comprising:
a defoamer.

11. The composition of claim 10, wherein the defoamer comprises a polyether siloxane copolymer emulsion.

12. The composition of claim 1, wherein the trisiloxane surfactant comprises Silsurf A004-UP.

13. The composition of claim 1, wherein the silicone compatibilizer comprises Silsurf Q25315-0.

14. A thermal imaging receiver system, comprising:
a substrate;
an image-receiving layer disposed on the substrate, the image-receiving layer comprising:
a dye-receiving layer (DRL) configured to receive thermally transferred dye from a donor element during thermal imaging, the DRL comprising:
a silicone compatibilizer; and
a trisiloxane surfactant;
a receiver overcoat (ROC) layer disposed over the DRL, the ROC layer comprising a polymer binder matrix, the polymer binder matrix comprising at least one of a water-dispersible acrylic polymer, a water-dispersible polyester, or a water-dispersible conductive polymeric material.

15. The thermal imaging receiver system of claim 14, wherein each of the DRL and the ROC layer comprise a release agent.

16. The thermal imaging receiver system of claim 14, further comprising:
one or more crosslinking agents comprising a carbodiimide or an aziridine reactive with carboxyl or carboxylate groups in the polymer binder matrix.

17. The thermal imaging receiver system of claim 14, wherein the DRL and the ROC layer are aqueous.

18. The thermal imaging receiver system of claim 14, wherein the image-receiving layer is coated on both opposing sides of the substrate to enable thermal dye transfer imaging on either or both sides of the substrate.

19. The thermal imaging receiver system of claim 14, wherein the trisiloxane surfactant comprises at least one of an ethoxylated polydimethylsiloxane, a distillate from a mono-functional trisiloxane intermediate, or a polyether-modified siloxane.

20. The thermal imaging receiver system of claim 14, wherein the silicone compatibilizer comprising at least one of a silicone polyether, a silicone glycol copolymer, an organo-modified silicone that is dispersible in water, a siloxane-based Gemini surfactant, a polyether siloxane copolymer, or a polyether-modified polydimethylsiloxane.
